(19) United States
(12) Patent Application Publication
(10) Pub. No.: US 2024/0421905 A1
(43) Pub. Date: Dec. 19, 2024

(54) PASSIVE WIRELESS COMMUNICATION USING A MODULATED REFLECTOR

(71) Applicant: Microsoft Technology Licensing, LLC, Redmond, WA (US)

(72) Inventors: Zerina KAPETANOVIC, Seattle, WA (US); Nissanka Arachchige Bodhi PRIYANTHA, Redmond, WA (US); Ranveer CHANDRA, Kirkland, WA (US); Vaishnavi RANGANATHAN, Seattle, WA (US)

(73) Assignee: Microsoft Technology Licensing, LLC, Redmond, WA (US)

(21) Appl. No.: 18/334,491

(22) Filed: Jun. 14, 2023

(51) Int. Cl. H04B 10/118; G02B 5/122; G02B 26/08; H04B 10/29

(52) U.S. Cl. CPC H04B 10/118; G02B 5/122; G02B 26/0816; H04B 10/29

(57) ABSTRACT

A passive communication system includes a first reflector and a modulator unit. The first reflector is disposed at a first location within line of sight of a first satellite. The first satellite is configured to transmit a first signal at a first wavelength. The first reflector includes a reflective surface that reflects at least a portion of the first signal which is incident on the reflective surface back toward the first satellite, and the first satellite includes a detector for measuring reflected signals received at the first satellite. The modulator unit is configured to modulate a reflectivity of the reflective surface of the first reflector between a first reflective state to a second reflective state to adjust the portion of the first signal which is incident on the reflective surface that is reflected back toward the first satellite.

### BACKGROUND

Satellite communication systems provide telecommunications and data communications across many areas of the planet. In a typical satellite communication system, a terrestrial transceiver is required to receive data from and/or transmit data to the satellites of the satellite communication system. However, such transceivers are often expensive and require a power source, which may not be readily available in some areas. Hence, there is a need for improved systems and methods of providing passive wireless communications that facilitate low or no power satellite communication.

### SUMMARY

An example passive communication system according to the disclosure includes a first reflector and a modulator unit. The first reflector is disposed at a first location within line of sight of a first satellite. The first satellite is configured to transmit a first signal at a first wavelength, and the first reflector includes a reflective surface that reflects at least a portion of the first signal which is incident on the reflective surface back toward the first satellite. The first satellite includes a detector for measuring reflected signals received at the first satellite. The modulator unit is configured to modulate a reflectivity of the reflective surface of the first reflector between a first reflective state to a second reflective state to adjust the portion of the first signal which is incident on the reflective surface that is reflected back toward the first satellite.

An example method implemented in a data processing system for passive wireless data communications according to the disclosure includes positioning a first reflector at a first location within line of sight of a first satellite, the first satellite configured to transmit a first signal at a first wavelength, the first reflector comprising a reflective surface that reflects at least a portion of the first signal which is incident on the reflective surface back toward the first satellite, the first satellite comprising a detector for measuring reflected signals received at the first satellite; and modulating the reflectivity of the reflective surface of the first reflector between a first reflective state to a second reflective state to adjust the portion of the first signal which is incident on the reflective surface that is reflected back toward the first satellite.

An example data processing system according to the disclosure may include a processor and a machine-readable medium storing executable instructions. The instructions when executed cause the processor alone or in combination with other processors to perform operations including obtaining measured reflected signal data measured by a detector of a first satellite, the first satellite being configured to transmit a first signal at a first wavelength and to measure reflected signal data that comprises a portion of the first signal reflected back to the first satellite, the reflected signal data including reflected signal data reflected by a first reflector disposed at a first location within a line of sight of the first satellite, the first reflector comprising a reflective surface that reflects at least a portion of the first signal which is incident on the reflective surface back toward the first satellite, the first reflector comprising a reflective surface that can be modulated between a first reflective state to a second reflective state to adjust the portion of the first signal which is incident on the reflective surface that is reflected back toward the first satellite; analyzing the measured reflected signal data to identify a measured reflective state of the first reflector in the reflected signal data; and performing one or more actions based on the measured reflective state of the first reflector.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram showing aspects of an example operating environment in which the techniques for passive wireless communication are implemented.

FIG. 1B is a diagram showing aspects of another example operating environment in which the techniques for passive wireless communication are implemented.

FIG. 1C is a diagram showing aspects of another example operating environment in which the techniques for passive wireless communication are implemented.

FIG. 1D shows examples of corner reflectors that may be used to implement the reflectors shown in FIGS. 1A-1C.

FIG. 2A includes a map showing the locations of two reflectors and the corresponding satellite data showing the reflected signals measured by the satellite.

FIG. 2B includes another map showing the locations of a reflector and the corresponding satellite data showing the reflected signals measured by the satellite.

FIG. 2C includes another map showing the locations of reflectors and the corresponding satellite data showing the reflected signals measured by the satellite.

FIG. 3A shows an example of an implementation of a reflective surface of a reflector that includes panels that can be rotated to modulate the reflectivity of the reflector.

FIG. 3B shows an example of an implementation of a reflective surface of a reflector that includes electrically controlled elements that can be selectively enabled or disabled to modulate the reflectivity of the reflector.

FIG. 4A shows an example implementation of the passive wireless communication system in which multiple reflectors are deployed and the reflectivity of the reflectors modulated to send multiple bits of data.

FIG. 4B shows an example implementation of the passive wireless communication system in which the reflectivity of the reflector is modulated to send multiple bits of data.

FIG. 5 is a diagram showing additional implementation details of the communication platform 165, the client device 150, and the data center 135 shown in FIG. 1C.

FIG. 6A is a flow chart of an example process for providing passive wireless communications according to the techniques provided herein.

FIG. 6B is a flow chart of another example process for providing passive wireless communications according to the techniques provided herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for implementing passive wireless communications using a modulated reflector are provided. These techniques provide a solution to the technical problems associated with providing wireless satellite communications in locations that are severely resource constrained and/or environments in which it would be impractical to implement a wireless transmitter. A typical wireless communication system would require a radio frequency (RF) transmitter. The transmitter equipment can be quite expensive and power intensive. Accordingly, the wireless transmitters may not be suitable for use in resource constrained environments where such equipment may be unavailable and/or a reliable power source to power such equipment is unavailable. Furthermore, certain environments may have harsh conditions that could damage or incapacitate a wireless transmitter. The techniques herein provide a passive wireless communication system that utilizes reflectors that have minimal or no power requirements that reflect RF signals transmitted by a satellite back to the satellite. The reflectors can be used to create a passive wireless communication channel by modulating the reflectivity of the reflective surface or surfaces of the reflectors to control how much of the RF signal incident on the reflector is transmitted back to the satellite. The reflector is a corner reflector, and the satellite is part of a synthetic aperture radar (SAR) system in some implementations. Other implementations may utilize other types of reflectors and other types of satellites systems that are configured to transmit and receive RF signals. The modulation can be implemented using mechanically controlled panels on the reflective surfaces that can be rotated to increase or decrease the reflectivity of the reflector. The rotation of the panels may be automated using a controller in some implementations or manually adjusted in other implementations. Other implementations may utilize an electronic means for increasing or decreasing the reflectivity of the reflective surfaces of the reflector. The techniques herein provide a low cost and low power solution to wireless communications that is passive and does not require generating an RF carrier. These and other technical benefits of the techniques disclosed herein will be evident from the discussion of the example implementations that follow.

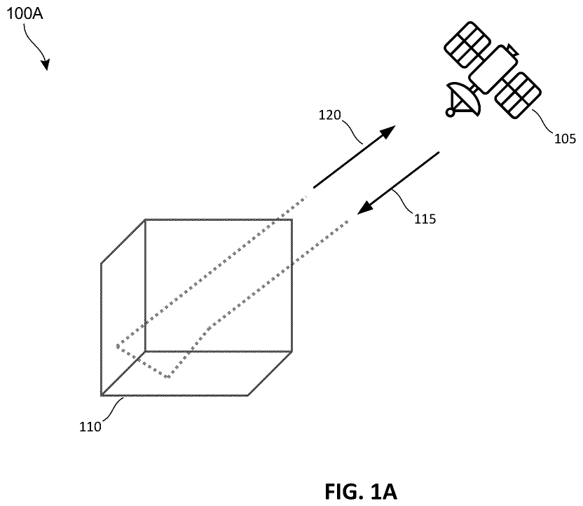

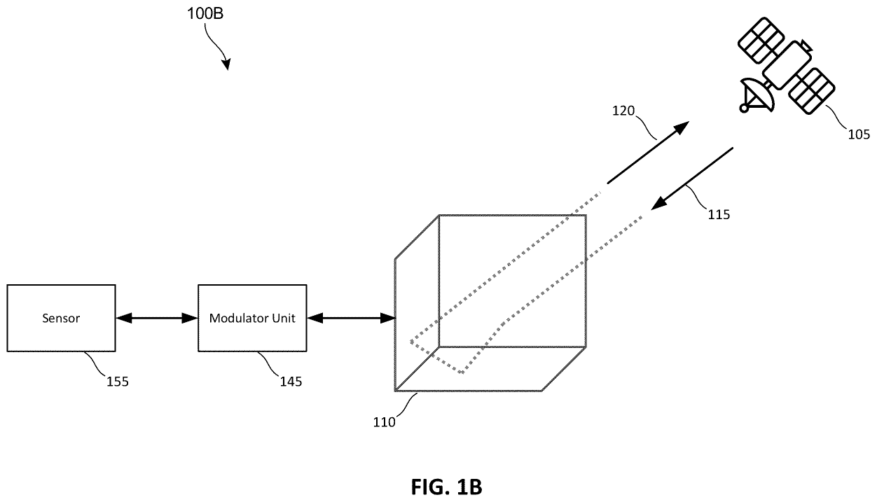

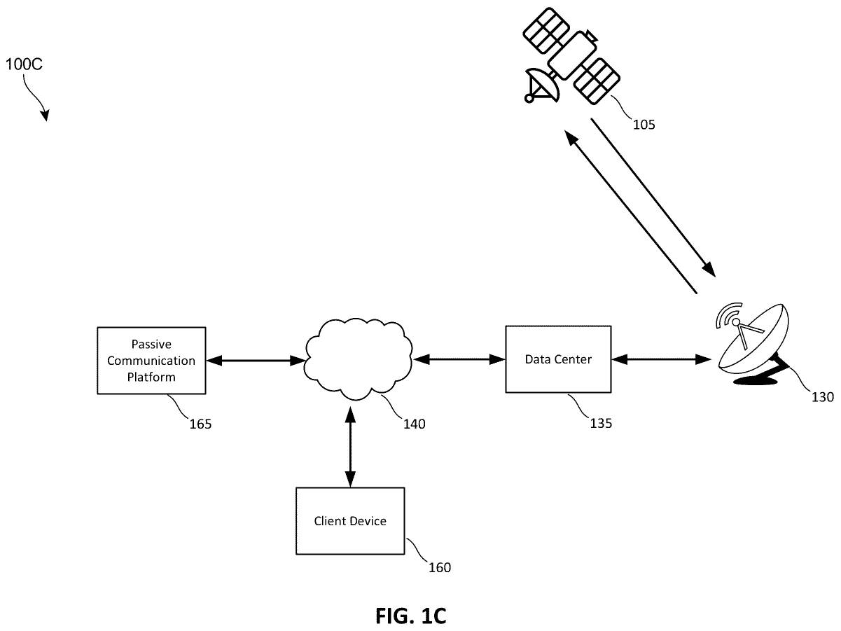

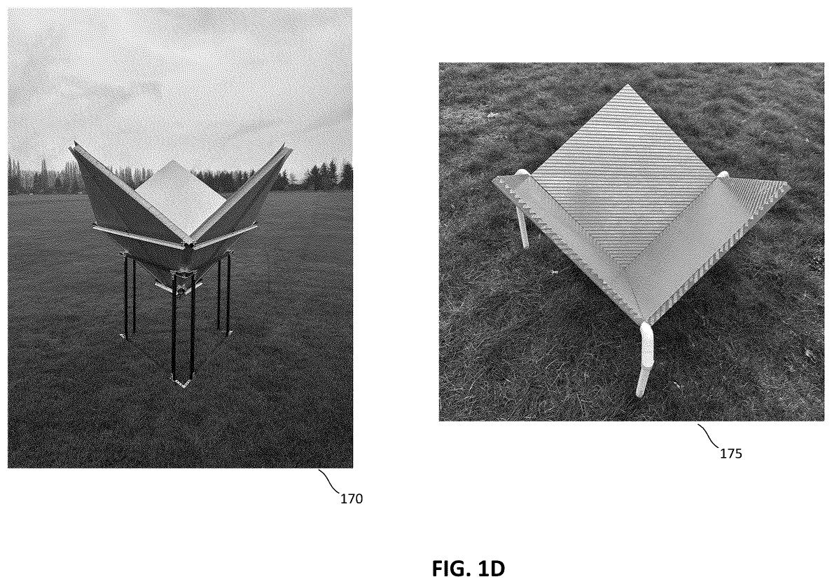

FIG. 1A is a diagram showing aspects of an example operating environment 100A in which the techniques for passive wireless communication are implemented. The computing environment 100A includes a reflector 110 and a satellite 105. In the example shown in FIG. 1A, the reflector 110 is a corner reflector that includes three mutually perpendicular, intersecting reflective surfaces which reflect RF signal back toward the source, which is the satellite 105 in this example implementation. FIG. 1D shows an example of a first reflector 170 and a second reflector 175, which may be used to implement the reflector 110 shown in FIGS. 1A and 1B. In some implementations, the satellite 105 is a synthetic aperture radar (SAR) satellite. SAR is a type of active radar that is used for a number of applications including environmental monitoring, mapping of Earth's resources, and military systems. There are a number of SAR equipped satellite systems, such as but not limited to Sentinel-1, that could be used to implement the passive wireless communication techniques provided herein.

The satellite 105 transmits an RF signal 115. The reflector 110 is placed in the line of sight of the satellite without any objects that may obstruct the RF signal 115 between the satellite 105 and the reflector 110. The reflector 110 is a corner reflector that includes three reflective surfaces that are configured to reflect at least a portion of the first signal which is incident on the reflective surfaces of the reflector 110 back to toward the satellite 105 as reflected signal 120. The reflector may include a modulator unit 145 that is configured to modulate the reflectivity of one or more of the reflective surfaces of the reflector 110 either automatically or manually. The modulator unit 145 modulates the reflectivity of one or more of the reflective surfaces of the reflector 110 from a first reflective state to a second reflective state to adjust the portion of the RF signal 115 incident on the reflective surfaces of the reflector 110 that is reflected back to the satellite 105 as the reflected signal 120. Decreasing the reflectivity of the one or more reflective surfaces of the reflector 110 decreases the strength of the reflected signal 120, while increasing the reflectivity of the one or more reflective surfaces of the reflector 110 increase the strength of the reflected signal 120. Modulating between these reflective states can be used to transmit bits of information as will be seen in the example implementations which follow.

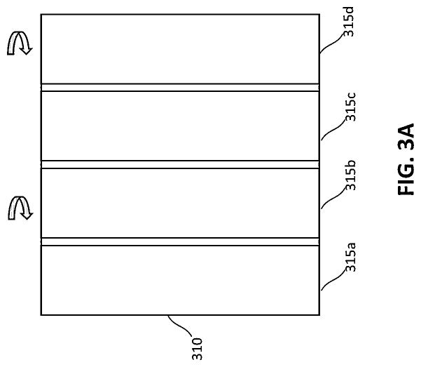

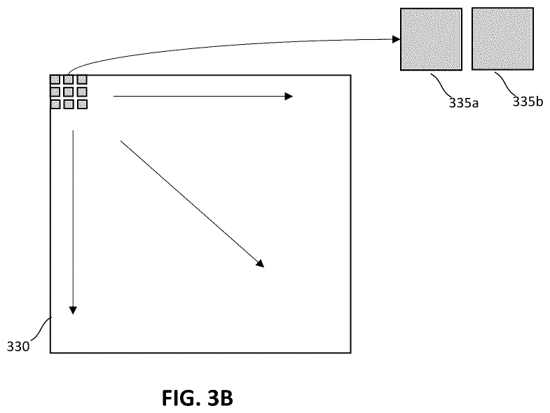

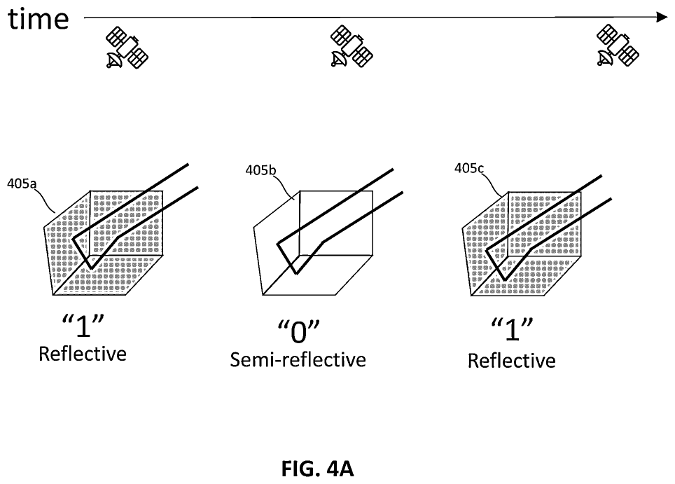

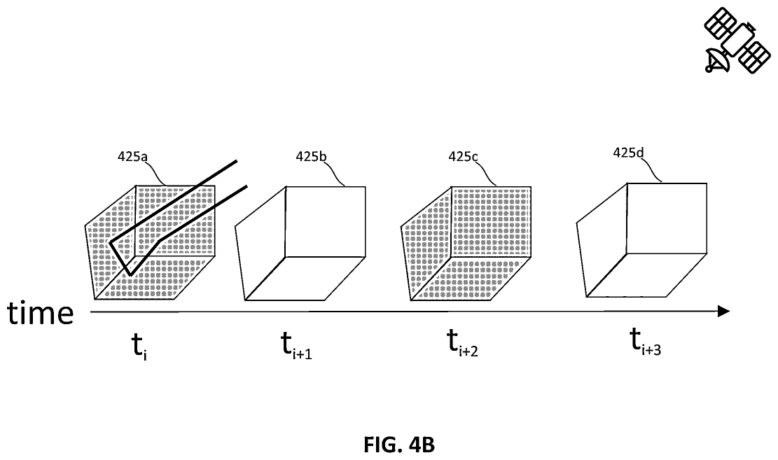

FIG. 1B shows an example implementation 100B of an operating environment similar to that shown in FIG. 1A, but the reflector 110 is associated with a modulator unit 145 that is configured to automatically modulate the reflectivity of one or more of the reflective surfaces of the reflector 110. Examples of how this modulation may be implemented are discussed with respect to FIGS. 3A and 3B, which are described in detail in the examples which follow. The modulator unit 145 is configured to receive a signal from a sensor 155 that is configured to output a sensor signal in response to detecting certain states of a monitored object or the occurrence of a particular condition. The modulator unit 145 is configured to modulate the reflectivity of one or more of the reflective surfaces of the reflector 110 based on the sensor signal. Various types of sensors may be used. For example, the sensor 155 may be used to measure changes in height and/or movement of the land or water due to seismic activity or tidal action. In other implementations, the sensor 155 is configured to detect the presence or absence of a specific chemical in the environment. For example, the sensor 155 may be placed in an area with volcanic activity to measure the presence of sulfur dioxide or other gases associated with volcanic activity. Other implementations may use one or more other types of sensors 155 to measure other types of conditions. As discussed with respect to the implementation shown in FIGS. 4A and 4B, the modulator unit 145 can be configured to modulate the reflectivity of one or more reflectors 110 to transmit multiple bits of information. This approach can be used to transmit multiple bits of data which may represent information obtained from multiple sensors. A technical benefit of the configuration shown in FIG. 1B is that the reflector-sensor combination may be placed in remote locations to monitor for the occurrence of various and to report the occurrence of these conditions using the passive wireless communication techniques provided herein. Another technical benefit is that these implementations require very low power to operate the sensor 155 and the modulator unit 145 compared with active wireless communication systems which utilize an RF transmitter to communicate with the satellite 105.

FIG. 1C is a diagram showing aspects of another example operating environment 100C in which the techniques for passive wireless communication are implemented. The computing environment 100C includes a communication platform 165, a client device 160, and a data center 135. The communication platform 165, the client device 160, and the data center 135 communicate with one another over the network 140. The network 140 may be implemented by one or more public and/or private networks and may be implemented at least in part by the Internet.

In the example 100C shown in FIG. 1C, the satellite 105 is in communication with a ground station 130 which is configured to send data to and receive data from the satellite 105. The satellite 105 sends reflected signal measurement information obtained by the satellite 105 to the ground station 130. The ground station 130 sends the reflected signal measurement information to the data center 135. The data center 135 processes the reflected signal measurement information received from one or more satellites 105 and may store the measurement information in a datastore for further analysis. The data center 135 may also expose an application programming interface (API) that enables users to access the data collected by the satellites and stored in the datastore. The data collected by some satellite systems is publicly available, such as but not limited to the Sentinel-1 system. Other satellite systems may require that users purchase a license to access and utilize the data collected by the satellite system.

The passive communication platform 165 provides tools that enable the data collected by the satellite 105 and/or other satellites of the satellite communication system to be analyzed. These tools include a user interface that enables the user to input the locations of one or more reflectors 110. The passive communication platform 165 automatically generates a query to obtain the signal measurement data obtained by the satellite 105 that includes potential signal returns from the one or more reflectors 110. The passive communication platform 165 may provide the user with the ability configure query parameters, such as a data range for which the signal measurement data is to be obtained. The passive communication platform 165 may also provide visualization and analysis tools analyzing the signal measurement data to extract bits of data represented by the reflective state of the reflective surfaces of the one or more reflectors 110. Additional details of how the reflectivity of the reflectors 110 may be modulated to convey data that can be detected by the satellite 105 are provided in the examples which follow.

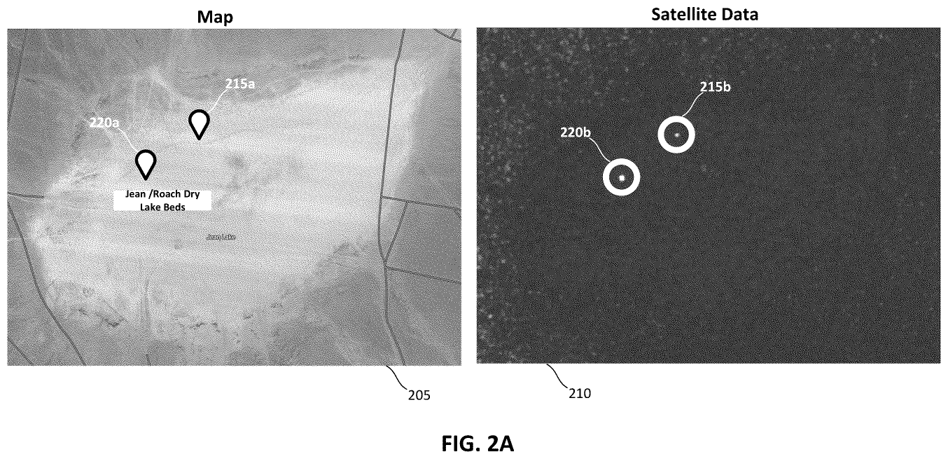

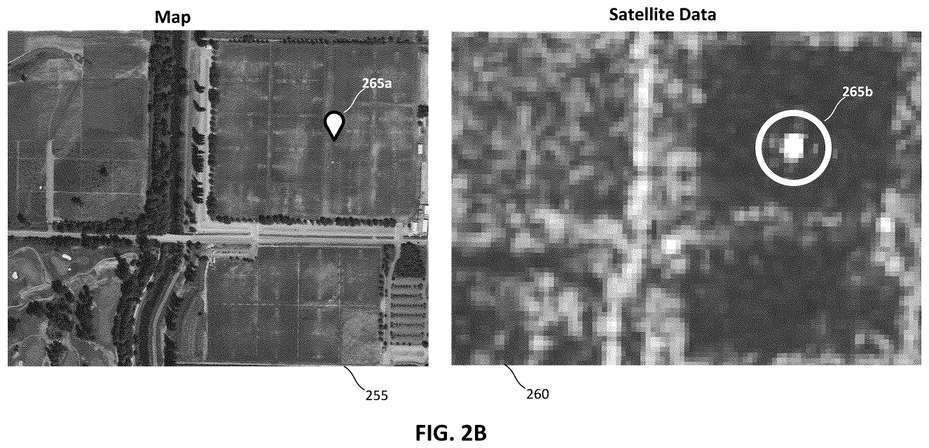

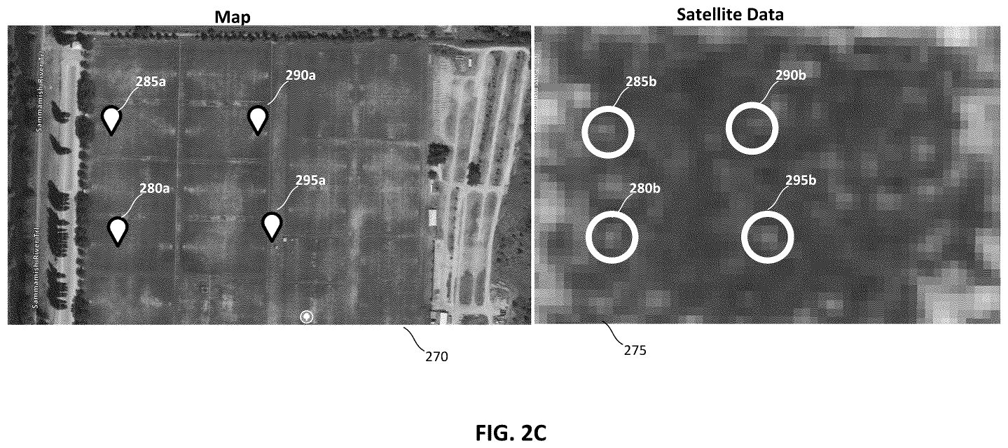

FIG. 2A includes a map 205 showing the locations of two reflectors 215a and 220a and the corresponding satellite data 210 showing the reflected signals 215b and 220b measured by the satellite 105 for the area corresponding to the map 205. The reflector 215a is a 2 foot by 2 foot (approximately 0.61 meter by 0.61 meter) sized corner reflector. The reflector 215b is a 4 foot by 4 foot (approximately 1.22 meter by 1.22 meter) sized corner reflector. The reflectivity of both the reflector 215a and the 215b is the same in this example.

FIG. 2B includes another map 255 showing the locations of a reflector 265a and the corresponding satellite data 260 showing the reflected signals 265b measured by the satellite 105. FIG. 2C includes a third map 270 showing the locations of three reflectors 280a, 285a, 290a, and 295a and the corresponding satellite data 275 showing the reflected signals 280b, 285b, 290b, and 295b. In the example shown in FIG. 2C, the reflectivity of the reflective surfaces of the reflectors 280a, 285a, 290a, and 295a have been modulated.

FIG. 3A shows an example of an implementation of a reflective surface 310 of a reflector 110 that includes panels 315a, 315b, 315c, and 315d that can be rotated to modulate the reflectivity of the reflector. The modulator unit 145 rotates the panels to adjust the angle of the panels 315a, 315b, 315c, and 315d to increase or decrease the reflectivity of the reflective surface of the reflector 110. In some implementations, the panels 315a, 315b, 315c, and 315d can be manually rotated by a person present at the location of the reflector 110. Such manual implementation can be used in resource constrained settings in which a motorized modulator unit 145 is unavailable.

FIG. 3B shows an example of an implementation of a reflective surface 330 of a reflector 110 that includes electrically controlled elements, including elements 335a and 335b, that can be selectively enabled or disabled to modulate the reflectivity of the reflector. The modulator unit 145 can apply an electrical signal to all or a portion of the electrically controlled elements to change the reflectivity of the reflector 110. In some implementations, the electrically controlled elements may be toggled between an opaque or partially opaque state to reduce the reflectivity of the reflective surface 330 and a transparent state in which the reflectivity of the reflective surface is unmodified by the electrically controlled elements.

FIG. 4A shows an example implementation of the passive wireless communication system in which multiple reflectors 405a, 405b, and 405c are deployed and the reflectivity of the reflectors modulated to send multiple bits of data. In the example implementation shown in FIG. 4A, the reflector 405a is modulated to a first reflective state having a higher reflectivity, the reflector 405b is modulated to a second reflective state having a lower reflectivity than the first reflective state, and the reflector 405c is modulated to the first reflective state. Using this approach, each reflector can convey a bit of information. The reflectors 405a, 405b, and 405c can be arranged in a known pattern so that it is possible to determine which reflector was set to represent a particular bit value.

FIG. 4B shows an example implementation of the passive wireless communication system in which the reflectivity of the reflector 425 is modulated for each time interval of a plurality of time intervals to send multiple bits of data. The time interval may vary from implementation to implementation and may be based at least in part on how long the satellite 105 will have a line of sight to the reflector 425, how often the satellite 105 transmits the signal 115, and/or other factors. In the example shown in FIG. 4B, the reflector 425a represents the reflector 425 at a first time interval, the reflector 425b represents the reflector 425 at a second time interval, the reflector 425c represents the reflector 425 at a third time interval, and the reflector 425d represents the reflector 425 at a fourth time interval. A technical benefit of this approach is that a single reflector can convey multiple bits of information for each pass of the satellite 105 using a single reflector. While the example shown in FIG. 4B includes a single reflector 425, other implementations include more than one reflector for which the reflectivity may be modulated at each time interval. A technical benefit of this approach is that the bitrate of the passive wireless communications can be significantly increased by modulating the reflectivity of multiple reflectors.

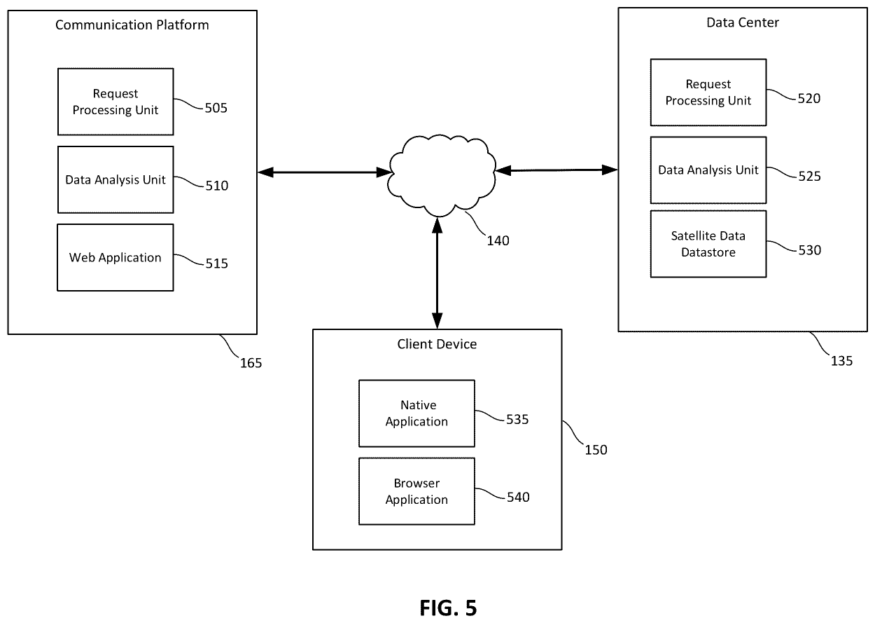

FIG. 5 is a diagram showing additional implementation details of the communication platform 165, the client device 150, and the data center 135 shown in FIG. 1C. The data center 135 includes a request processing unit 520, a data analysis unit 525, and a satellite data datastore 530. The data analysis unit 525 processes the measured reflected signal data measured by a detector of the satellite 105 and received by the ground station 130. The raw data is processed by the data analysis unit 525 to facilitate storing the reflected signal data in the satellite data datastore 530. The satellite data datastore 530 is a persistent datastore for storing the data acquired by the satellites of the satellite system, including the satellite 105. The satellite data datastore 530 is configured to support queries for reflected signal data measured by the detector of the satellite. The satellite data datastore 530 supports querying based on location and time period to enable data for specific reflectors for specified time periods to be retrieved and analyzed. The request processing unit 520 is configured to receive requests from the passive communication platform 165 and/or the client device 150 for specific reflected signal data, to execute the query on the satellite data datastore 530, and to return the query results to the client device 160 or the passive communication platform 165.

The communication platform 165 includes a request processing unit 505, a data analysis unit 525, and a web application 515. The request processing unit 505 is configured to receive requests from the web application 515 of the communication platform 165 or the native application 535 of the client device 150 to query for reflected signal data from the data center 135. The data analysis unit 510 is configured to analyze reflected signal data obtained from the data center 135 to identify the location of reflectors in the data and a reflective state of those reflectors. The data analysis unit 510 is also configured to perform other types of analysis on the reflected signal data such as identifying bit patterns in the data resulting from modulation of the reflectivity of the reflective surfaces of the reflectors.

The client device 150 is a computing device that may be implemented as a portable electronic device, such as a mobile phone, a tablet computer, a laptop computer, a portable digital assistant device, a portable game console, and/or other such devices in some implementations. The client device 150 may also be implemented in computing devices having other form factors, such as a desktop computer, vehicle onboard computing system, a kiosk, a point-of-sale system, a video game console, and/or other types of computing devices in other implementations. While the example implementation illustrated in FIGS. 1C and 5 includes a single client device 150, other implementations may include a different number of client devices that utilize service provided by the passive communication platform 165.

The client device 150 includes a browser application 540 and/or web-enabled native application 535. The browser application 540 is configured to access web-based content, such as but not limited to the web application 515 provided by the communication platform 165. The native application 535 implement at least a portion of the functionality of the web application 515 on the client device 150 and other functionality is provided by web-based content provided by the web application 515 of the communication platform 165 in some implementations. The browser application 540 and/or the native application 535 can be used to query for reflected signal data from the data center 135, view the reflected signal data associated with reflectors, analyze this data, and/or create new content from the data.

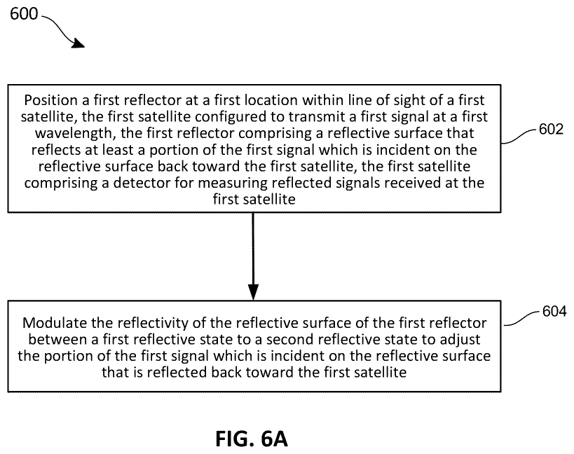

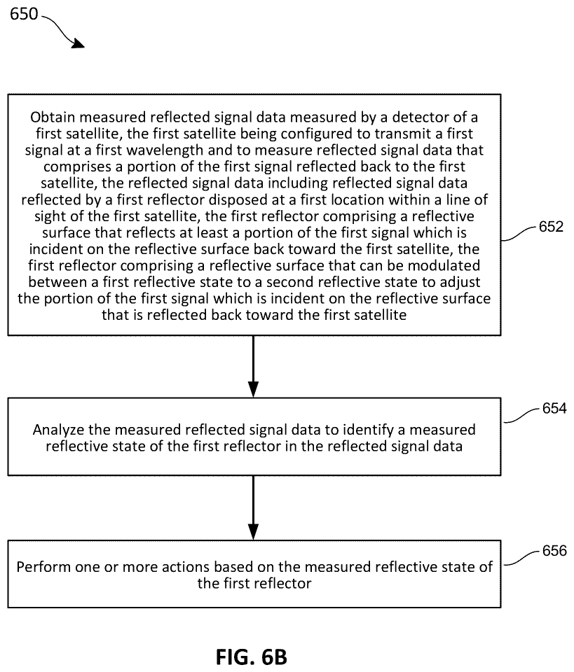

FIG. 6A is an example flow chart of an example process 600 for providing passive wireless communications according to the techniques provided herein. The process 600 may be implemented by the reflector 110 shown in FIGS. 1A and 1B using the techniques described in the preceding examples.

The process 600 includes an operation 602 of positioning a first reflector at a first location within line of sight of a first satellite. The first reflector is implemented by the reflector 110 shown in the preceding examples in some implementations and may be a corner reflector. The first satellite is implemented by the satellite 105 shown in the preceding examples. The first satellite is configured to transmit a first signal 115 at a first wavelength. The first reflector includes a reflective surface that reflects at least a portion of the first signal which is incident on the reflective surface back toward the first satellite. In some implementations, the first reflector is implemented by a corner reflector, such as those shown in the preceding examples. The first satellite comprising a detector for measuring reflected signals received at the first satellite.

The process 600 includes an operation 604 of modulating the reflectivity of the reflective surface of the first reflector between a first reflective state to a second reflective state to adjust the portion of the first signal which is incident on the reflective surface that is reflected back toward the first satellite. As discussed in the preceding examples, the modulator unit 145 modulates the reflectivity of the reflective surface of the reflector in some implementations.

FIG. 6B is an example flow chart of an example process 650 for providing passive wireless communications according to the techniques provided herein. The process 650 may be implemented by the client device 160 and/or the passive communication platform 165 using the techniques described in the preceding examples.

The process 650 includes an operation 652 of obtaining measured reflected signal data measured by a detector of a first satellite. The first satellite is configured to transmit a first signal at a first wavelength and to measure reflected signal data that includes a portion of the first signal reflected back to the first satellite. The reflected signal data including reflected signal data reflected by a first reflector disposed at a first location within a line of sight of the first satellite. The first reflector includes a reflective surface that reflects at least a portion of the first signal which is incident on the reflective surface back toward the first satellite. The first reflector includes a reflective surface that can be modulated between a first reflective state to a second reflective state to adjust the portion of the first signal which is incident on the reflective surface that is reflected back toward the first satellite.

The process 650 includes an operation 654 of analyzing the measured reflected signal data to identify a measured reflective state of the first reflector in the reflected signal data and an operation 656 of performing one or more actions based on the measured reflective state of the first reflector. As discussed in the preceding examples, the measured reflected signal data can be analyzed to identify a bit of data or bits of data that have been captured in the reflected signal data measured by the satellite 105. As discussed in the preceding example, these bits of data can be used to convey information using passive wireless communications. The bits of data can be determined based on sensor data from one or more sensors, such as the sensor 155 shown in the preceding examples. Such sensor data can be used to detect the occurrence of certain conditions at the location of the reflector 110, and the modulator unit conveys that information to the satellite 105 by modulating the reflectivity of the reflector or reflectors 110.

The detailed examples of systems, devices, and techniques described in connection with FIGS. 1-6B are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6B are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

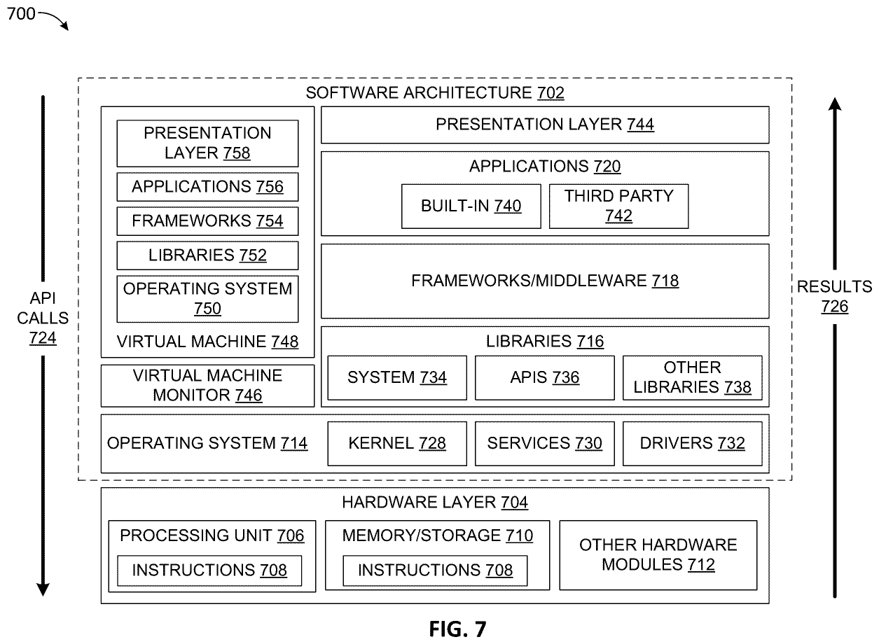

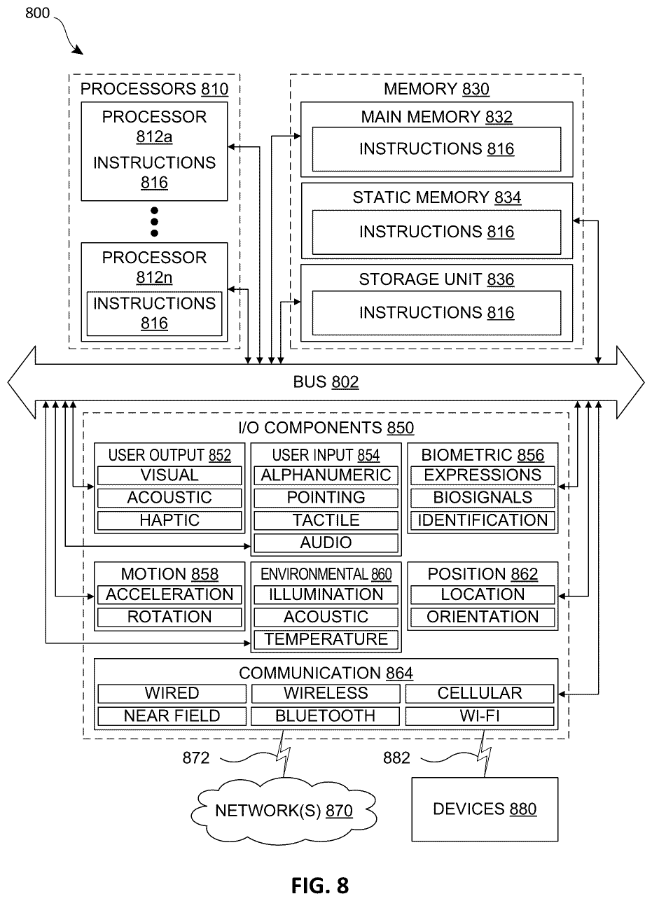

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the following, further features, characteristics, and advantages of the invention will be described by means of items:
Item 1. A passive communication system comprising:
   a first reflector disposed at a first location within line of sight of a first satellite, the first satellite configured to transmit a first signal at a first wavelength, the first reflector comprising a reflective surface that reflects at least a portion of the first signal which is incident on the reflective surface back toward the first satellite, the first satellite comprising a detector for measuring reflected signals received at the first satellite; and
   a modulator unit configured to modulate a reflectivity of the reflective surface of the first reflector between a first reflective state to a second reflective state to adjust the portion of the first signal which is incident on the reflective surface that is reflected back toward the first satellite.
Item 2. The passive communication system of item 1, wherein the first satellite is a synthetic aperture radar (SAR) satellite.
Item 3. The passive communication system of any of items 1 or 2, wherein the first reflector comprises a corner reflector comprising three mutually perpendicular reflecting surfaces that reflect the at least a portion of the first signal back toward the first satellite.
Item 4. The passive communication system of any of items 1-3, wherein the reflective surface comprises a plurality of rotatable panels, and wherein the modulator unit is configured to generate a first signal to cause the plurality of panels to rotate to a first orientation to place the reflective surface in the first reflective state and to generate a second signal to cause the plurality of panels to rotate to second orientation to place the reflective surface in the second reflective state.
Item 5. The passive communication system of any of item 1-3, wherein the reflective surface comprises a plurality of rotatable panels, and wherein the modulator unit includes a control mechanism which when actuated by a user causes the modulator unit to rotate to a first orientation to place the reflective surface in the first reflective state or to rotate to a first orientation to place the reflective surface in the first reflective state.
Item 6. The passive communication system of any of items 1-3, wherein the reflective surface comprises a plurality of electrically controlled panels, and wherein the modulator unit is configured to generate a first signal to cause the plurality of electrically controlled panels to place the reflective surface in the first reflective state and to generate a second signal to cause the plurality of panels to place the reflective surface in the second reflective state.
Item 7. The passive communication system of any of items 1-4 and 6, wherein the modulator unit is configured to receive a signal from a first sensor, and wherein the modulator unit is configured to modulate the reflectivity of the reflective surface to the first reflective state responsive to the first sensor signal indicating a first state detected by the first sensor and to modulate the reflectivity of the reflective surface to the second reflective state responsive to a second sensor signal indicating a second state detected by the second sensor.
Item 8. The passive communication system of any of items 1-4 and 6, wherein the modulator unit is configured to modulate the reflectivity of the reflective surface between the first reflective state and the second reflective state over a period of time to transmit multiple bits of data, wherein each bit of data is represented by a current reflective state of the reflective surface for a specified interval of time.
Item 9. The passive communication system of any of items 1-4 and 6, wherein the passive communication system includes a plurality of reflectors including the first reflector, and wherein the modulator unit is configured to selectively modulate the reflectivity of each reflector of the plurality of reflectors to either the first reflective state or the second reflective state, wherein each reflector of the plurality of reflectors represents a bit of data.
Item 10. The passive communication system of any of items 1-9, further comprising a computing device configured to receive reflected signal data measured by the detector of the first satellite and to analyze the reflected signal data, and to perform one or more actions based on the reflective state of the first reflector.
Item 11. A method for passive wireless data communications, the method comprising:
   positioning a first reflector at a first location within line of sight of a first satellite, the first satellite configured to transmit a first signal at a first wavelength, the first reflector comprising a reflective surface that reflects at least a portion of the first signal which is incident on the reflective surface back toward the first satellite, the first satellite comprising a detector for measuring reflected signals received at the first satellite; and
   modulating the reflectivity of the reflective surface of the first reflector between a first reflective state to a second reflective state to adjust the portion of the first signal which is incident on the reflective surface that is reflected back toward the first satellite.
Item 12. The method of item 11, wherein the first satellite is a synthetic aperture radar (SAR) satellite.
Item 13. The method of any of items 11 or 12, wherein the first reflector comprises a corner reflector comprising three mutually perpendicular reflecting surfaces that reflect the at least a portion of the first signal back toward the first satellite.
Item 14. The method of any of items 11-13, wherein the reflective surface comprises a plurality of rotatable panels, and wherein modulating the reflectivity of the reflective surface of the first reflector further comprises:
   generating a first signal to cause the plurality of panels to rotate to a first orientation to place the reflective surface in the first reflective state; and
   generating a second signal to cause the plurality of panels to rotate to a second orientation to place the reflective surface in the second reflective state.
Item 15. The method of any of items 11-13, wherein the reflective surface comprises a plurality of electrically controlled panels, and wherein modulating the reflectivity of the reflective surface of the first reflector further comprises:
   generating a first signal to cause the plurality of electrically controlled panels to place the reflective surface in the first reflective state;
   generating a second signal to cause the plurality of panels to place the reflective surface in the second reflective state.
Item 16. A data processing system comprising:
   a processor; and
   a machine-readable storage medium storing executable instructions that, when executed, cause the processor alone or in combination with other processors to perform operations of:
      obtaining measured reflected signal data measured by a detector of a first satellite, the first satellite being configured to transmit a first signal at a first wavelength and to measure reflected signal data that comprises a portion of the first signal reflected back to the first satellite, the reflected signal data including reflected signal data reflected by a first reflector disposed at a first location within a line of sight of the first satellite, the first reflector comprising a reflective surface that reflects at least a portion of the first signal which is incident on the reflective surface back toward the first satellite, the first reflector comprising a reflective surface that can be modulated between a first reflective state to a second reflective state to adjust the portion of the first signal incident on the reflective surface that is reflected back toward the first satellite;
      analyzing the measured reflected signal data to identify a measured reflective state of the first reflector in the reflected signal data; and
      performing one or more actions based on the measured reflective state of the first reflector.
Item 17. The data processing system of item 16, wherein the first satellite is a synthetic aperture radar (SAR) satellite.
Item 18. The data processing system of any of items 16 or 17, wherein the measured reflective state of the first reflector represents a condition measured by a sensor associated with the first reflector.
Item 19. The data processing system of any of items 16-18, wherein analyzing the reflected signal data to identify a measured reflective state of the first satellite in the reflected signal data further comprises:
   identifying changes in the measured reflective state of the first reflector in the reflected signal data to identify a pattern in the changes in the measured reflective state; and
   performing the one or more actions based on the pattern.
Item 20. The data processing system of any of items 16-18, wherein the measured reflected signal data includes reflected signal data from a plurality of reflectors including the first reflector, and wherein analyzing the reflected signal data further comprises:
   identifying changes in the measured reflective state of each reflector of the plurality of reflectors in the reflected signal data to identify a pattern in the measured reflective state; and
   performing the one or more actions based on the pattern.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A passive communication system comprising:
a first reflector disposed at a first location within line of sight of a first satellite, the first satellite configured to transmit a first signal at a first wavelength, the first reflector comprising a reflective surface that reflects at least a portion of the first signal which is incident on the reflective surface back toward the first satellite, the first satellite comprising a detector for measuring reflected signals received at the first satellite; and
a modulator unit configured to modulate a reflectivity of the reflective surface of the first reflector between a first reflective state to a second reflective state to adjust the portion of the first signal which is incident on the reflective surface that is reflected back toward the first satellite.

2. The passive communication system of claim 1, wherein the first satellite is a synthetic aperture radar (SAR) satellite.

3. The passive communication system of claim 1, wherein the first reflector comprises a corner reflector comprising three mutually perpendicular reflecting surfaces that reflect the at least a portion of the first signal back toward the first satellite.

4. The passive communication system of claim 1, wherein the reflective surface comprises a plurality of rotatable panels, and wherein the modulator unit is configured to generate a first signal to cause the plurality of panels to rotate to a first orientation to place the reflective surface in the first reflective state and to generate a second signal to cause the plurality of panels to rotate to second orientation to place the reflective surface in the second reflective state.

5. The passive communication system of claim 1, wherein the reflective surface comprises a plurality of rotatable panels, and wherein the modulator unit includes a control mechanism which when actuated by a user causes the modulator unit to rotate to a first orientation to place the reflective surface in the first reflective state or to rotate to a first orientation to place the reflective surface in the first reflective state.

6. The passive communication system of claim 1, wherein the reflective surface comprises a plurality of electrically controlled panels, and wherein the modulator unit is configured to generate a first signal to cause the plurality of electrically controlled panels to place the reflective surface in the first reflective state and to generate a second signal to cause the plurality of panels to place the reflective surface in the second reflective state.

7. The passive communication system of claim 1, wherein the modulator unit is configured to receive a signal from a first sensor, and wherein the modulator unit is configured to modulate the reflectivity of the reflective surface to the first reflective state responsive to the first sensor signal indicating a first state detected by the first sensor and to modulate the reflectivity of the reflective surface to the second reflective state responsive to a second sensor signal indicating a second state detected by the second sensor.

8. The passive communication system of claim 1, wherein the modulator unit is configured to modulate the reflectivity of the reflective surface between the first reflective state and the second reflective state over a period of time to transmit multiple bits of data, wherein each bit of data is represented by a current reflective state of the reflective surface for a specified interval of time.

9. The passive communication system of claim 1, wherein the passive communication system includes a plurality of reflectors including the first reflector, and wherein the modulator unit is configured to selectively modulate the reflectivity of each reflector of the plurality of reflectors to either the first reflective state or the second reflective state, wherein each reflector of the plurality of reflectors represents a bit of data.

10. The passive communication system of claim 1, further comprising a computing device configured to receive reflected signal data measured by the detector of the first satellite and to analyze the reflected signal data, and to perform one or more actions based on the reflective state of the first reflector.

11. A method for passive wireless data communications, the method comprising:
positioning a first reflector at a first location within line of sight of a first satellite, the first satellite configured to transmit a first signal at a first wavelength, the first reflector comprising a reflective surface that reflects at least a portion of the first signal which is incident on the reflective surface back toward the first satellite, the first satellite comprising a detector for measuring reflected signals received at the first satellite; and
modulating the reflectivity of the reflective surface of the first reflector between a first reflective state to a second reflective state to adjust the portion of the first signal which is incident on the reflective surface that is reflected back toward the first satellite.

12. The method of claim 11, wherein the first satellite is a synthetic aperture radar (SAR) satellite.

13. The method of claim 11, wherein the first reflector comprises a corner reflector comprising three mutually perpendicular reflecting surfaces that reflect the at least a portion of the first signal back toward the first satellite.

14. The method of claim 12, wherein the reflective surface comprises a plurality of rotatable panels, and wherein modulating the reflectivity of the reflective surface of the first reflector further comprises:
generating a first signal to cause the plurality of panels to rotate to a first orientation to place the reflective surface in the first reflective state; and
generating a second signal to cause the plurality of panels to rotate to a second orientation to place the reflective surface in the second reflective state.

15. The method of claim 12, wherein the reflective surface comprises a plurality of electrically controlled panels, and wherein modulating the reflectivity of the reflective surface of the first reflector further comprises:
generating a first signal to cause the plurality of electrically controlled panels to place the reflective surface in the first reflective state;
generating a second signal to cause the plurality of panels to place the reflective surface in the second reflective state.

16. A data processing system comprising:
a processor; and
a machine-readable storage medium storing executable instructions that, when executed, cause the processor alone or in combination with other processors to perform operations of:
obtaining measured reflected signal data measured by a detector of a first satellite, the first satellite being configured to transmit a first signal at a first wavelength and to measure reflected signal data that comprises a portion of the first signal reflected back to the first satellite, the reflected signal data including reflected signal data reflected by a first reflector disposed at a first location within a line of sight of the first satellite, the first reflector comprising a reflective surface that reflects at least a portion of the first signal which is incident on the reflective surface back toward the first satellite, the first reflector comprising a reflective surface that can be modulated between a first reflective state to a second reflective state to adjust the portion of the first signal incident on the reflective surface that is reflected back toward the first satellite;
analyzing the measured reflected signal data to identify a measured reflective state of the first reflector in the reflected signal data; and
performing one or more actions based on the measured reflective state of the first reflector.

17. The data processing system of claim 16, wherein the first satellite is a synthetic aperture radar (SAR) satellite.

18. The data processing system of claim 16, wherein the measured reflective state of the first reflector represents a condition measured by a sensor associated with the first reflector.

19. The data processing system of claim 16, wherein analyzing the reflected signal data to identify a measured reflective state of the first satellite in the reflected signal data further comprises:
identifying changes in the measured reflective state of the first reflector in the reflected signal data to identify a pattern in the changes in the measured reflective state; and
performing the one or more actions based on the pattern.

20. The data processing system of claim 16, wherein the measured reflected signal data includes reflected signal data from a plurality of reflectors including the first reflector, and wherein analyzing the reflected signal data further comprises:
identifying changes in the measured reflective state of each reflector of the plurality of reflectors in the reflected signal data to identify a pattern in the measured reflective state; and
performing the one or more actions based on the pattern.
